(19) United States
(12) Patent Application Publication
(10) Pub. No.: US 2021/0344503 A1
(43) Pub. Date: Nov. 4, 2021

(54) SLAVE DEVICE AND COMPUTER READABLE MEDIUM

(71) Applicant: MITSUBISHI ELECTRIC CORPORATION, Tokyo (JP)

(72) Inventor: Koki IGAWA, Tokyo (JP)

(73) Assignee: MITSUBISHI ELECTRIC CORPORATION, Tokyo (JP)

(21) Appl. No.: 17/375,611

(22) Filed: Jul. 14, 2021

Related U.S. Application Data
(63) Continuation of application No. PCT/JP2019/008012, filed on Mar. 1, 2019.

(51) Int. Cl. H04L 9/32; H04L 9/06; H04L 12/28

(52) U.S. Cl. CPC H04L 9/3242; H04L 12/28; H04L 9/0618

(57) ABSTRACT

A reception unit (221) receives a frame destined for a master located on an upstream side from a slave located on a downstream side. Using a received message authentication code, which is a message authentication code included in the received frame, a concatenation relay unit (230) calculates an intermediate computation result of the received message authentication code. The concatenation relay unit concatenates transmission data, which is to be transmitted to the master, to a transmission data string included in the received frame. The concatenation relay unit calculates a message authentication code for a concatenated transmission data string, using the intermediate computation result. A transmission unit (224) transmits a frame including the concatenated transmission data string and also including the message authentication code calculated using the intermediate computation result, instead of the received message authentication code, to the upstream side.

### CROSS REFERENCE TO RELATED APPLICATIONS

This application is a Continuation of PCT International Application No. PCT/JP2019/008012, filed on Mar. 1, 2019, all of which is hereby expressly incorporated by reference into the present application.

### TECHNICAL FIELD

The present invention relates to transmission of a frame from a slave to a master.

### BACKGROUND ART

In a field network in a control system, a linear daisy-chained network is often adopted.

In the linear daisy-chained network, one master and N slaves are connected linearly.

Introduction of a message authentication code (MAC) for the purpose of guaranteeing the integrity of communication data from each slave to the master in the linear daisy-chained network will be considered.

Upon receiving a frame transmitted from each slave, the master verifies the integrity of data in the frame by verifying a MAC attached to the frame.

In this case, the master needs to verify N MACs for the N slaves. Therefore, the load on the master for MAC verification is heavy.

Patent Literature 1 discloses a frame concatenation scheme.

In the frame concatenation scheme, when each slave receives a frame from a physically adjacent slave, each slave concatenates its own data to data in the frame.

By adopting the frame concatenation scheme, the load on the master for MAC verification can be reduced.

Each slave attaches a MAC for concatenated data to the frame, and relays the frame. When the master receives a frame from a physically adjacent slave, the master verifies one MAC attached to the frame. By this, the integrity of the data from each slave in the frame is verified. Therefore, the number of MACs to be verified by the master is reduced, so that the load on the master for MAC verification can be reduced.

Patent Literature 2 discloses a method for reducing the load for signature verification for the purpose of preventing falsification of collected data in a data collection server in a data collection system composed of the data collection server and a plurality of gateway devices. In this method, each gateway device sequentially concatenates its own data to data received from another gateway device, further adds a signature in a superimposed manner, and then transmits the data. The signature to be superimposed here is only a signature (aggregated signature) generated from a signature received from the other gateway device and the own data. Therefore, each gateway device is configured such that there is no need to generate a plurality of signatures. As a result, not only the signature verification load on the data collection server can be reduced similarly to the expected effect resulting from adopting the frame concatenation scheme, but also the signature attaching load on each gateway device can be prevented from increasing.

However, in Patent Literature 2, CRC is mainly assumed as a signature. Patent Literature 2 only discloses a technique related to an aggregated signature generation method in which a signature to be attached to transmission data is generated based on a received signature. CRC is an abbreviation for Cyclic Redundancy Check.

A received MAC cannot be directly used for calculating a MAC to be transmitted.

Non-Patent Literature 1 discloses a MAC based on a block cipher (CMAC).

### CITATION LIST

### Patent Literature

Patent Literature 1: JP 5393528 B

Patent Literature 2: JP 2015-23375 A

### Non-Patent Literature

Non-Patent Literature 1: Morris Dworkin, “Recommendation for Block Cipher Modes of Operation: The CMAC Mode for Authentication”, NIST Special Publication 800-38B, 2005.

### SUMMARY OF INVENTION

### Technical Problem

The frame concatenation scheme has problems as described below.

Each slave calculates a MAC for concatenated data of its own data and data of another slave. The amount of MAC computation for the concatenated data is larger than the amount of MAC computation for the own data. That is, the load on each slave for MAC attachment increases. This increases a delay in relaying a frame in each salve.

Generally, a communication period constraint is required of a control system. For this reason, the master needs to complete the reception of a frame from each slave such that the communication period constraint is satisfied. However, if a delay in relaying the frame increases in each slave, the delay in relaying accumulates in proportion to the number of slaves that relay the frame, and the communication period constraint may not be able to be satisfied.

It is an object of the present invention to make it possible to satisfy a communication period constraint.

### Solution to Problem

A slave device according to the present invention includes
a reception unit to receive a frame destined for a master located on an upstream side from a slave located on a downstream side;
an intermediate-computation-result calculation unit to calculate an intermediate computation result, using a received message authentication code, which is a message authentication code included in the received frame, the intermediate computation result being obtained by computing a part of a computation expression for calculating the received message authentication code;
a transmission data concatenation unit to concatenate transmission data, which is to be transmitted to the master, to a transmission data string included in the received frame;
a message authentication code calculation unit to calculate a message authentication code for a concatenated transmission data string, using the intermediate computation result; and
a transmission unit to transmit a frame including the concatenated transmission data string and including the message authentication code calculated using the intermediate computation result, instead of the received message authentication code, to the upstream side.

### Advantageous Effects of Invention

According to the present invention, the amount of computation for a message authentication code (MAC) is reduced. Therefore, a delay in relaying a frame is reduced in each slave. As a result, a communication period constraint can be satisfied.

### BRIEF DESCRIPTION OF DRAWINGS

FIG. 1 is a configuration diagram of a control system 100 in a first embodiment;

FIG. 2 is a configuration diagram of a slave device 200 in the first embodiment;

FIG. 3 is a configuration diagram of a communication management unit 220 in the first embodiment;

FIG. 4 is a configuration diagram of a concatenation relay unit 230 in the first embodiment;

FIG. 5 is a configuration diagram of a storage unit 290 in the first embodiment;

FIG. 6 is a configuration diagram of a master device 300 in the first embodiment;

FIG. 7 is a flowchart illustrating a transmission process of the slave device 200 in the first embodiment;

FIG. 8 is a flowchart illustrating a reception process of the slave device 200 in the first embodiment;

FIG. 9 is a flowchart of a concatenation relay process (S140) in the first embodiment;

FIG. 10 is a diagram illustrating frames (111 to 114) in the first embodiment;

FIG. 11 is a configuration diagram of the communication management unit 220 in a second embodiment;

FIG. 12 is a configuration diagram of the storage unit 290 in the second embodiment;

FIG. 13 is a configuration diagram of the master device 300 in the second embodiment;

FIG. 14 is a configuration diagram of a segment management unit 330 in the second embodiment;

FIG. 15 is a flowchart illustrating a reception process of the slave device 200 in the second embodiment;

FIG. 16 is a flowchart illustrating a segment determination process of the master device 300 in the second embodiment;

FIG. 17 is a hardware configuration diagram of the slave device 200 in the embodiments; and

FIG. 18 is a hardware configuration diagram of the master device 300 in the embodiments.

### DESCRIPTION OF EMBODIMENTS

In the embodiments and drawings, the same elements or corresponding elements are denoted by the same reference sign. The description of an element denoted by the same reference sign as that of an element that has been described will be suitably omitted or simplified. In the drawings, arrows mainly indicate flows of data or flows of processing.

### First Embodiment

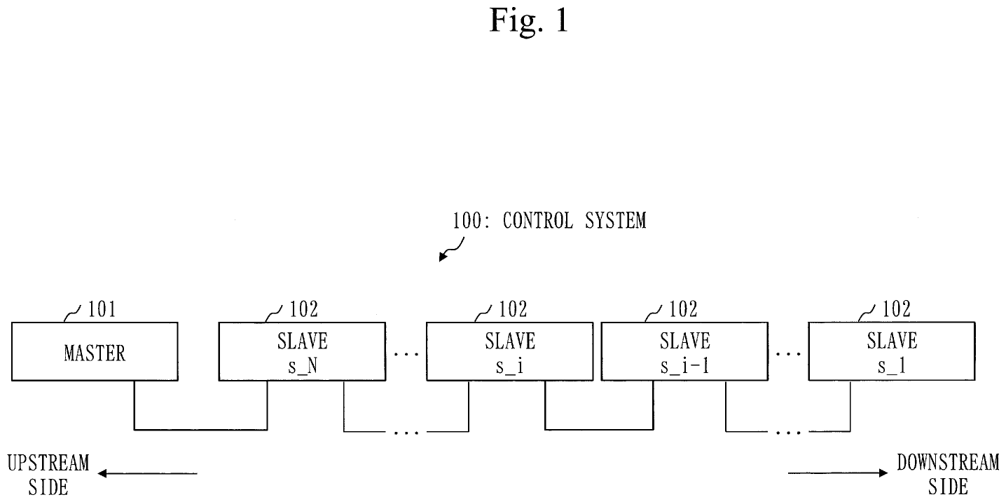

Based on FIGS. 1 to 10, a control system 100 in which a linear daisy-chained network is adopted will be described.

Description of Configuration

Based on FIG. 1, a configuration of the control system 100 will be described.

The control system 100 includes a master 101 and a plurality of slaves (s_1 to s_N) and realizes specific control. “N” is an integer of 2 or more.

The slave located farthest from the master 101 will be referred to as the slave s_1.

The slave located nearest to the master 101 will be referred to as the slave s_N.

The slave at the (i−1)-th position when counted from the slave s_1 will be referred to as a slave s_i−1, and the salve at the i-th position when counted from the slave s_1 will be referred to as a slave s_i. Note that “i” is an integer from 2 to (N−1).

When the slaves are not identified individually, each slave will be referred to as a slave 102.

In a field network in the control system 100, a configuration in which the master 101 and a plurality of slaves 102 are connected linearly is adopted. Such a configuration will be referred to as a linear daisy-chained network.

In the linear daisy-chained network, the side on which the master 101 is located will be referred to as an “upstream side”, and the side on which the slave s_1 is located will be referred to as a “downstream side”.

That is, the slave s_N is the most upstream slave 102, and the slave s_1 is the most downstream slave 102.

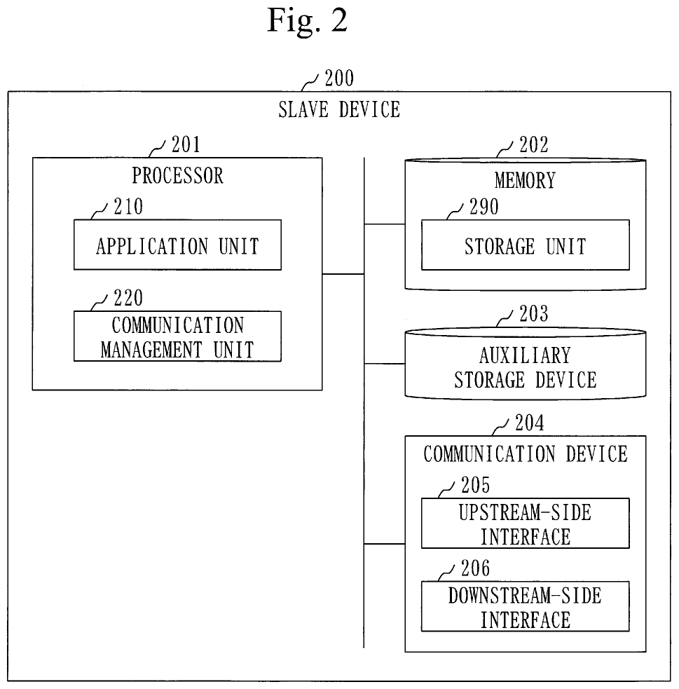

Based on FIG. 2, a configuration of a slave device 200 will be described.

The slave device 200 is a computer that functions as the slave 102, and includes hardware components such as a processor 201, a memory 202, an auxiliary storage device 203, and a communication device 204. These hardware components are connected with one another via signal lines.

The processor 201 is an IC that performs operational processing and controls the other hardware components. For example, the processor 201 is a CPU, a DSP, or a GPU.

IC is an abbreviation for Integrated Circuit.

CPU is an abbreviation for Central Processing Unit.

DSP is an abbreviation for Digital Signal Processor.

GPU is an abbreviation for Graphics Processing Unit.

The memory 202 is a volatile storage device. The memory 202 is also called a main storage device or a main memory. For example, the memory 202 is a RAM. Data stored in the memory 202 is saved in the auxiliary storage device 203 as necessary.

RAM is an abbreviation for Random Access Memory.

The auxiliary storage device 203 is a non-volatile storage device. For example, the auxiliary storage device 203 is a ROM, an HDD, or a flash memory. Data stored in the auxiliary storage device 203 is loaded into the memory 202 as necessary.

ROM is an abbreviation for Read Only Memory.

HDD is an abbreviation for Hard Disk Drive.

The communication device 204 is a receiver and a transmitter. For example, the communication device 204 is a communication chip or a NIC. NIC is an abbreviation for Network Interface Card.

The communication device 204 includes an upstream-side interface 205 and a downstream-side interface 206. The upstream-side interface 205 is a communication interface that is connected on the upstream side of the linear daisy-chained network. The downstream-side interface 206 is a communication interface that is connected on the downstream side of the linear daisy-chained network.

The communication of the slave device 200 is realized by the communication device 204.

The slave device 200 includes elements such as an application unit 210 and a communication management unit 220. These elements are realized by software.

The auxiliary storage device 203 stores a slave program for causing a computer to function as the application unit 210 and the communication management unit 220. The slave program is loaded into the memory 202 and executed by the processor 201.

The auxiliary storage device 203 further stores an OS. At least part of the OS is loaded into the memory 202 and executed by the processor 201.

The processor 201 executes the slave program while executing the OS.

OS is an abbreviation for Operating System.

Input data and output data of the slave program are stored in a storage unit 290.

The memory 202 functions as the storage unit 290. However, a storage device such as the auxiliary storage device 203, a register in the processor 201, and a cache memory in the processor 201 may function as the storage unit 290 in place of the memory 202 or together with the memory 202.

The slave device 200 may include a plurality of processors as an alternative to the processor 201. The plurality of processors share the role of the processor 201.

The slave program can be recorded (stored) in a computer readable format in a non-volatile recording medium such as an optical disc or a flash memory.

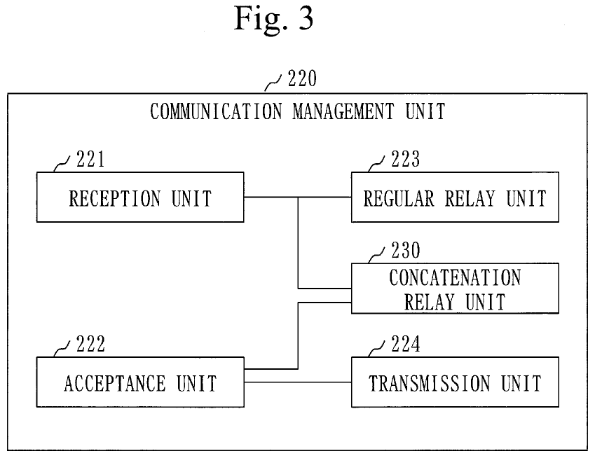

Based on FIG. 3, a configuration of the communication management unit 220 will be described.

The communication management unit 220 includes a reception unit 221, an acceptance unit 222, a regular relay unit 223, a transmission unit 224, and a concatenation relay unit 230.

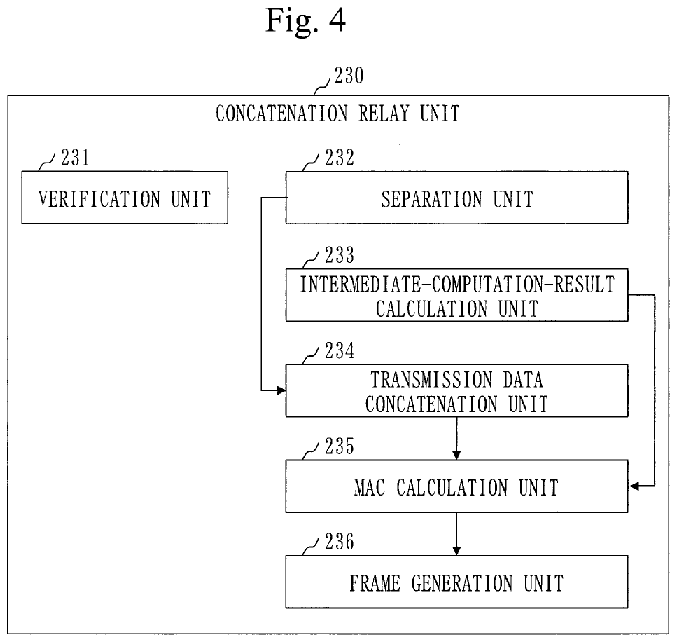

Based on FIG. 4, a configuration of the concatenation relay unit 230 will be described.

The concatenation relay unit 230 includes a verification unit 231.

The concatenation relay unit 230 further includes a separation unit 232, an intermediate-computation-result calculation unit 233, a transmission data concatenation unit 234, a MAC calculation unit 235, and a frame generation unit 236.

“MAC” is an abbreviation for a message authentication code. A specific message authentication code is a message authentication code based on a block cipher (CMAC).

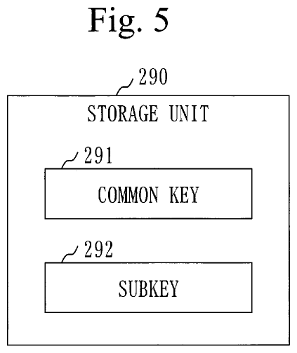

Based on FIG. 5, a configuration of the storage unit 290 will be described.

In the storage unit 290, a common key 291, a subkey 292, and so on are pre-stored.

The common key 291 is the common key used in a computation expression for calculating a MAC (MAC computation expression). The same common key 291 is used in each of the slaves 102.

The subkey 292 is the subkey corresponding to the common key 291. The same subkey 292 is used in each of the slaves 102.

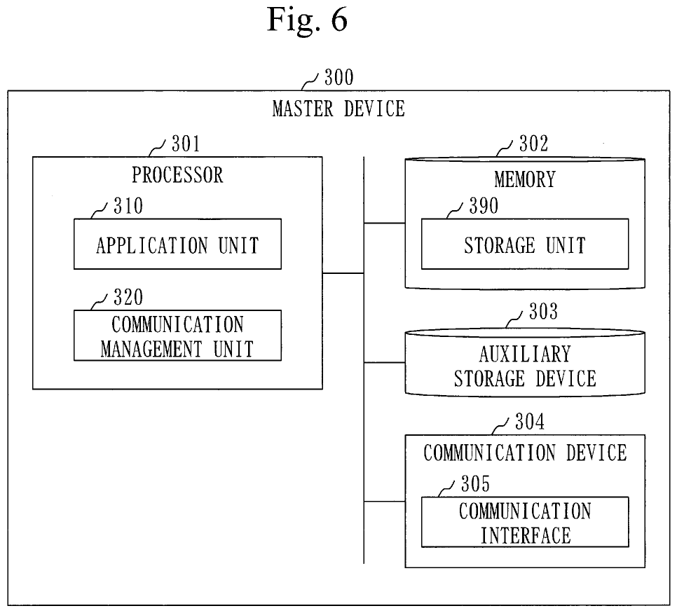

Based on FIG. 6, a configuration of the master device 300 will be described.

The master device 300 is a computer that functions as the master 101 and includes hardware components such as a processor 301, a memory 302, an auxiliary storage device 303, and a communication device 304. These hardware components are connected to one another via signal lines.

The processor 301 is an IC that performs operational processing and controls the other hardware components. For example, the processor 301 is a CPU, a DSP, or a GPU.

The memory 302 is a volatile storage device. The memory 302 is also called a main storage device or a main memory. For example, the memory 302 is a RAM. Data stored in the memory 302 is saved in the auxiliary storage device 303 as necessary.

The auxiliary storage device 303 is a non-volatile storage device. For example, the auxiliary storage device 303 is a ROM, an HDD or a flash memory. Data stored in the auxiliary storage device 303 is loaded into the memory 302 as necessary.

The communication device 304 is a receiver and a transmitter. For example, the communication device 304 is a communication chip or a NIC.

The communication device 304 includes a communication interface 305. The communication interface 305 is connected to the linear daisy-chained network.

The communication of the master device 300 is realized by the communication device 304.

The master device 300 includes elements such as an application unit 310 and a communication management unit 320. These elements are realized by software.

The auxiliary storage device 303 stores a master program for causing a computer to function as the application unit 310 and the communication management unit 320. The master program is loaded into the memory 302 and executed by the processor 301.

The auxiliary storage device 303 further stores an OS. At least part of the OS is loaded into the memory 302 and executed by the processor 301.

The processor 301 executes the master program while executing the OS.

Input data and output data of the master program are stored in a storage unit 390. For example, the same keys as the common key 291 and the subkey 292 are pre-stored in the storage unit 390.

The memory 302 functions as the storage unit 390. However, a storage device such as the auxiliary storage device 303, a register in the processor 301, and a cache memory in the processor 301 may function as the storage unit 390 in place of the memory 302 or together with the memory 302.

The master device 300 may include a plurality of processors as an alternative to the processor 301. The plurality of processors share the role of the processor 301.

The master program can be recorded (stored) in a computer readable format in a non-volatile recording medium such as an optical disc or a flash memory.

Description of Operation

Operation of the control system 100 corresponds to a control method. A procedure of the control method corresponds to a procedure of a control program.

A procedure for operation of the slave device 200 corresponds to a procedure of the slave program. A procedure for operation of the master device 300 corresponds to a procedure of the master program.

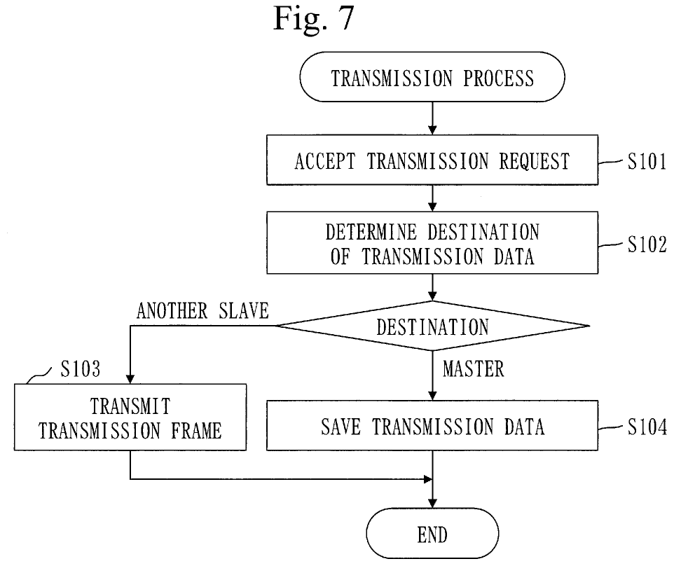

Based on FIG. 7, a transmission process of the slave device 200 will be described.

The transmission process of the slave device 200 is performed when transmission data is generated in the application unit 210.

The application unit 210 generates transmission data, and outputs a set of a transmission request and the transmission data. The set of the transmission request and the transmission data is input to the communication management unit 220.

In step S101, the acceptance unit 222 accepts the set of the transmission request and the transmission data.

The transmission request includes information that identifies the destination of the transmission data (destination information).

In step S102, the acceptance unit 222 determines the destination of the transmission data based on the destination information included in the transmission request.

If the destination of the transmission data is another slave 102, the process proceeds to step S103.

If the destination of the transmission data is the master 101, the process proceeds to step S104.

In step S103, the transmission unit 224 generates a frame including the transmission data destined for the other slave 102. At this time, the transmission unit 224 may calculate a MAC for the transmission data, using the common key 291, and attach the calculated MAC to the frame.

Then, the transmission unit 224 transmits the generated frame to the other slave 102.

For example, the transmission unit 224 transmits the generated frame as described below.

Configuration information data of the control system 100 is pre-stored in the storage unit 290. The configuration information data of the control system 100 indicates the configuration of the control system 100.

The transmission unit 224 determines whether the other slave 102 is the slave 102 on the upstream side or the slave 102 on the downstream side, based on the configuration information data of the control system 100.

If the other slave is the slave on the upstream side, the transmission unit 224 transmits the generated frame to the upstream side.

If the other slave is the slave on the downstream side, the transmission unit 224 transmits the generated frame to the downstream side.

In step S104, the acceptance unit 222 stores the transmission data destined for the master in the storage unit 290. The transmission of the transmission data destined for the master will be described later.

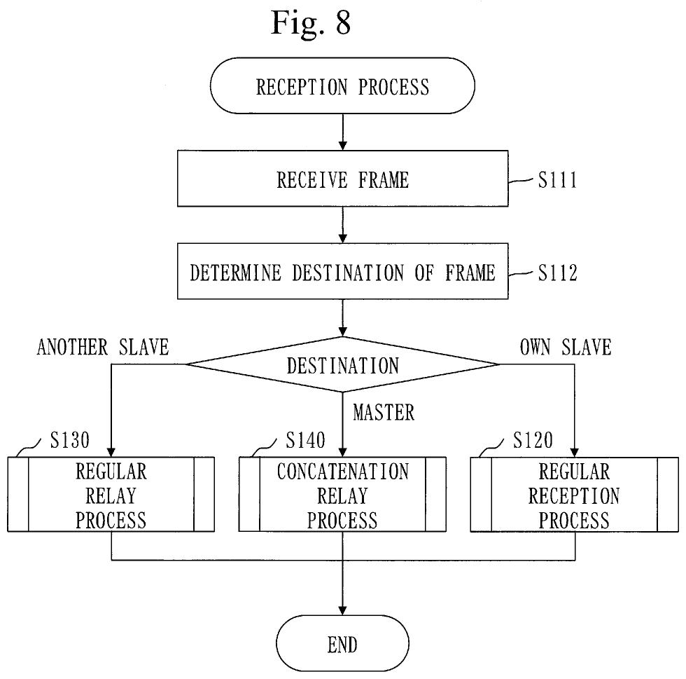

Based on FIG. 8, a reception process of the slave device 200 will be described.

The reception process of the slave device 200 is performed when a frame arrives at the slave device 200.

In step S111, the reception unit 221 receives the frame.

In step S112, the reception unit 221 refers to the header of the received frame and determines the destination of the received frame.

If the destination of the received frame is the own slave 102, the process proceeds to step S120.

If the destination of the received frame is another slave 102, the process proceeds to step S130.

If the destination of the received frame is the master 101, the process proceeds to step S140.

A regular reception process (S120) will be described.

The regular reception process (S120) is a conventional process to be performed when a frame destined for the own slave is received.

For example, the slave device 200 operates as described below.

The reception unit 221 stores the frame destined for the own slave 102 in the storage unit 290, and notifies the application unit 210 that the frame has been received.

The application unit 210 processes the frame destined for the own slave 102.

A regular relay process (S130) will be described.

The regular relay process (S130) is a conventional process to be performed when a frame destined for another slave is received.

For example, the slave device 200 operates as described below.

The reception unit 221 transfers the frame destined for the other slave 102 to the regular relay unit 223.

The regular relay unit 223 transmits the transferred frame to the other slave 102.

For example, the regular relay unit 223 transmits the transferred frame as described below.

The configuration information data of the control system 100 is pre-stored in the storage unit 290. The configuration information data of the control system 100 indicates the configuration of the control system 100.

The regular relay unit 223 determines whether the other slave 102 is the slave 102 on the upstream side or the slave 102 on the downstream side, based on the configuration information data of the control system 100.

If the other slave 102 is the slave 102 on the upstream side, the regular relay unit 223 transmits the transferred frame to the upstream side.

If the other slave 102 is the slave 102 on the downstream side, the regular relay unit 223 transmits the transferred frame to the downstream side.

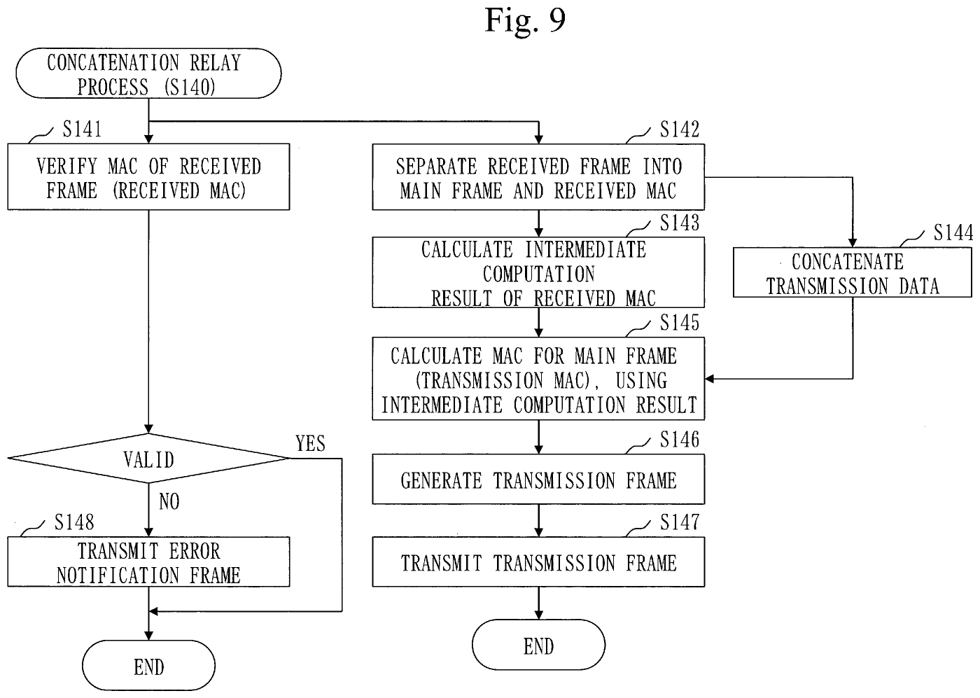

Based on FIG. 9, a concatenation relay process (S140) will be described.

The concatenation relay process (S140) is a process to be performed when a frame destined for the master 101 is received from the slave 102 on the downstream side.

The reception unit 221 transfers the frame destined for the master 101 to the concatenation relay unit 230. The transferred frame will be referred to as a “received frame”. The MAC attached to the received frame will be referred to as a “received MAC”.

In step S141, the verification unit 231 verifies the MAC for the received frame (received MAC). The method for verifying the received MAC is the same as a conventional method for verifying a MAC.

The verification of the MAC takes time, so that step S142 to step S147 are performed in parallel with step S141.

In step S142, the separation unit 232 separates the received frame into a main frame and the received MAC. In other words, the separation unit 232 extracts the main frame and the received MAC from the received frame.

The main frame is a portion of the received frame excluding the received MAC, and includes a transmission data string.

The transmission data string is one or more pieces of transmission data to be transmitted from one or more slaves 102 to the master 101.

The received MAC is the MAC for the main frame in the received frame.

After step S142, the process proceeds to step S143 and step S144.

In step S143, the intermediate-computation-result calculation unit 233 calculates an intermediate computation result of the received MAC.

The intermediate computation result of the received MAC is a value obtained by computing a part of the computation expression for computing the received MAC.

A method for calculating the intermediate computation result of the received MAC will be described later.

After step S143, the process proceeds to step S145.

In step S144, the transmission data concatenation unit 234 acquires the transmission data from the own slave 102 to the master 101 (see S104 of FIG. 7) from the storage unit 290.

Then, the transmission data concatenation unit 234 concatenates the acquired transmission data to the transmission data string in the main frame.

After step S144, the process proceeds to step S145.

In step S145, the MAC calculation unit 235 calculates a MAC for a concatenated main frame, using the intermediate computation result of the received MAC.

The concatenated main frame is the main frame obtained by step S144, and includes a concatenated transmission data string.

A method for calculating the MAC for the concatenated main frame will be described later.

The MAC for the concatenated main frame will be referred to as a “transmission MAC”.

In step S146, the frame generation unit 236 generates a frame destined for the master 101 by attaching the transmission MAC to the concatenated main frame. The generated frame will be referred to as a “transmission frame”.

In step S147, the transmission unit 224 transmits the transmission frame to the upstream side.

The transmission frame includes the concatenated transmission data string and also includes the transmission MAC instead of the received MAC.

The process after completion of the verification of the received MAC in step S141 will be described.

If the received MAC is determined as valid, the process ends.

If the received MAC is determined as invalid, the process proceeds to step S148.

In step S148, the verification unit 231 notifies the transmission unit 224 that the received MAC is invalid.

The transmission unit 224 generates an error notification frame destined for the master 101, and transmits the error notification frame to the upstream side.

The error notification frame is a frame for notifying that the received MAC is invalid.

The method for calculating the intermediate computation result of the received MAC (see step S143 of FIG. 9) and the method for calculating the transmission MAC (see step S145 of FIG. 9) will be described below.

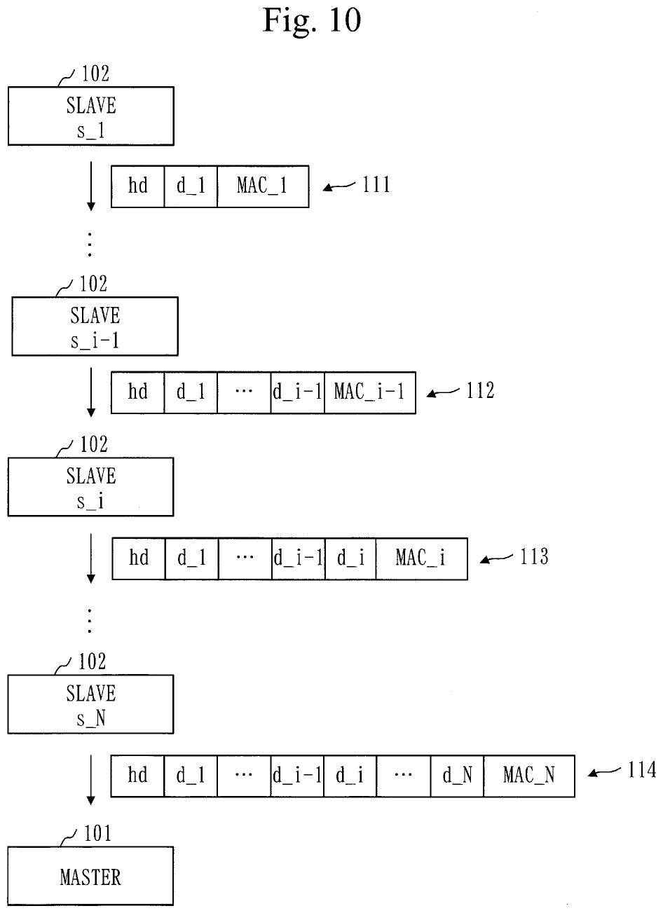

First, based on FIG. 10, configurations of frames destined for the master 101 will be described.

Note that “hd” is the header of a frame destined for the master 101.

Note that “d_x” is transmission data of a slave x.

Note that “MAC_x” is the MAC that is attached to a transmission frame by the slave x.

A frame 111 is a transmission frame of the slave s_1. MAC_1 of the frame 111 is the MAC for transmission data d_1.

A frame 112 is a transmission frame of the slave s_i−1. MAC_i−1 of the frame 112 is the MAC for a transmission data string {d_1, . . . , d_i−1}.

A frame 113 is a transmission frame of the slave s_i. MAC_i of the frame 113 is the MAC for a transmission data string {d_1, . . . , d_i−1, d_i}.

A frame 114 is a transmission frame of the slave s_N. MAC_N of the frame 114 is the MAC for a transmission data string {d_1, . . . , d_i−1, d_i, . . . , d_N}.

For simplicity of description, it is assumed that the number of bits in the transmission data of each of the slaves 102 is a multiple of a block size B.

The method for calculating the intermediate computation result of the received MAC (see step S143 of FIG. 9) will now be described.

It is assumed that the slave 102 that has calculated the received MAC is the slave s_i−1 and the slave 102 that is to calculate the intermediate computation result of the received MAC is the slave s_i. That is, it is assumed that the received MAC is MAC_i−1 (see FIG. 10).

In the slave s_i−1, the received MAC is calculated by computing expression (1-1).

$$[ Formula 1 ]$$

$$MAC\_i - 1 = E ( \underbrace{E ( … E ( E ( {r}_{i 1} ) ⊕ {r}_{i 2} ) … ) ⊕ {r}_{ip}}_{t \_ i - 1} ⊕ subkey ) \qquad ( 1 \text{-} 1 )$$

Note that “MAC_i−1” is the received MAC.

Note that “E(b)” is a bit string b encrypted using the common key 291.

Note that {rᵢₗ, . . . , rᵢₚ} is a set of bit strings rᵢₓ. The set of bit strings rix is obtained by dividing the transmission data string {d_1, . . . , d_i−1} included in the received frame by the block size B into p portions.

Note that “subkey” is the subkey 292.

The circle symbol with “+” inside denotes an XOR operation. “XOR” denotes exclusive OR.

When a portion of expression (1-1) is replaced with “t_i−1”, expression (1-2) is obtained.

[Formula 2]

MAC_i−1=E(t_i−1⊕subkey) (1-2)

Expression (1-2) is expanded into expression (1-3).

[Formula 3]

t_i−1=D(MAC_i−1)⊕subkey (1-3)

Note that “D(MAC_i−1)” is a value obtained by a decryption operation performed on the received MAC using the common key 291.

The intermediate-computation-result calculation unit 233 calculates an intermediate computation result t_i−1 of the received MAC by computing expression (1-3).

That is, the intermediate-computation-result calculation unit 233 calculates the intermediate computation result t_i−1 by one decryption operation and one XOR operation.

The method for calculating the transmission MAC (see step S145 of FIG. 9) will now be described.

It is assumed that the slave 102 that is to calculate the transmission MAC is the slave s_i. That is, it is assumed that the transmission MAC is MAC_i (see FIG. 10).

The transmission MAC can be calculated by computing expression (1-4).

$$[ Formula 4 ]$$

$$MAC\_i = E ( E ( … E ( E ( \underbrace{E ( … E ( E ( {r}_{i 1} ) ⊕ {r}_{i 2} ) … ) ⊕ {r}_{ip}}_{t \_ i - 1} ) ⊕ {v}_{i 1} ) ⊕ {v}_{i 2} … ) ⊕ {v}_{iq} ⊕ subkey \qquad ( 1 \text{-} 4 )$$

Note that “MAC_i” is the transmission MAC.

Note that {vᵢₗ, . . . , v_{iq}} is a set of bit strings v_{iy}. The set of bit strings v_{iy} is obtained by dividing the transmission data of the slave s_i by the block size B into q portions.

A portion of expression (1-4) is common with the portion “t_i−1” of expression (1-1).

When the portion of expression (1-4) is replaced with “t_i−1”, expression (1-5) is obtained.

[Formula 5]

MAC_i=E(E( . . . E(E(t_i−1)⊕vᵢ₁)⊕vᵢ₂. . . )⊕v_{iq}≢subkey) (1-5)

The MAC calculation unit 235 calculates the transmission MAC by computing expression (1-5) using the intermediate computation result t_i−1.

By calculating the transmission MAC using the intermediate computation result t_i−1, the portion of expression (1-4) can be omitted. That is, p−1 times of the encryption operation and p−2 times of the XOR operation can be omitted.

Lastly, operation of the master device 300 will be described.

The master device 300 operates similarly to a conventional master in a linear daisy-chained network.

For example, the master device 300 operates as described below.

When a frame arrives at the master device 300, the communication management unit 320 receives the frame. The frame that has been received will be referred to as a received frame.

Then, the communication management unit 320 verifies the MAC for the received frame.

If the MAC for the received frame is valid, or no MAC is included in the received frame, the communication management unit 320 determines whether the received frame is a regular frame or an error notification frame.

If the received frame is a regular frame, the communication management unit 320 stores the received frame in the storage unit 390 and notifies the application unit 310 that the regular frame has been received. The application unit 310 processes the received frame.

If the received frame is an error notification frame, the communication management unit 320 notifies the application unit 310 of a relay error. The application unit 310 performs processing for the relay error.

If the MAC for the received frame is invalid, the communication management unit 320 notifies the application unit 310 of the invalid MAC. The application unit 310 performs processing for the invalid MAC.

### Effects of First Embodiment

The first embodiment allows MAC_i in the slave s_i to be calculated using an intermediate computation result obtained by back calculation based on MAC_i−1 included in a received frame. Therefore, even when the frame concatenation scheme and MAC are applied to communication between a master and slaves in a linear daisy-chained network, the MAC attaching load on each slave can be reduced. As a result, a delay in relaying a frame is reduced in each slave, and a communication period constraint can be satisfied.

### Second Embodiment

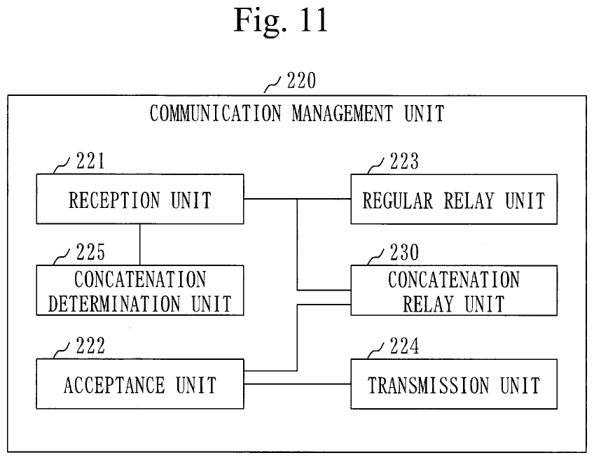

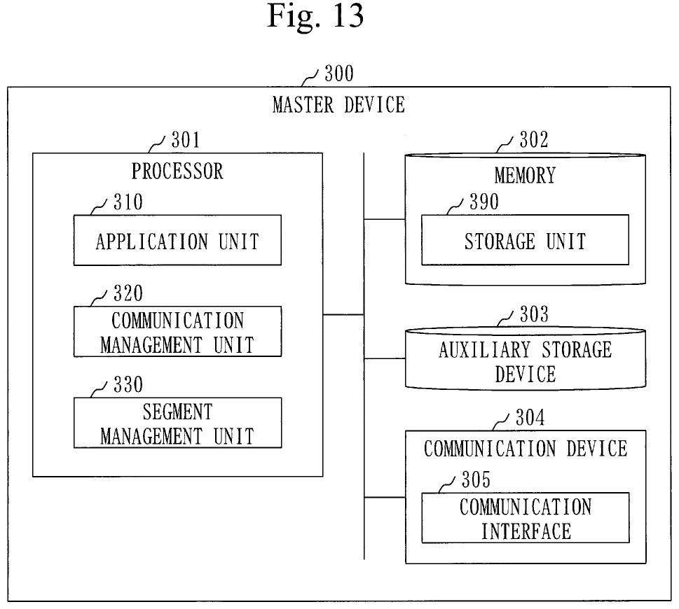

With regard to an embodiment in which a frame reaches at the master 101 from the most downstream slave 102 within a constraint time required of the control system 100, differences from the first embodiment will be mainly described based on FIGS. 11 to 16.

Description of Configuration

The configuration of the control system 100 is the same as the configuration in the first embodiment (see FIG. 1).

The configuration of the slave device 200 is the same as the configuration in the first embodiment except for the configuration of the communication management unit 220 and the configuration of the storage unit 290 (see FIG. 2).

Based on FIG. 11, the configuration of the communication management unit 220 will be described.

The communication management unit 220 further includes a concatenation determination unit 225. The rest of the configuration is the same as the configuration in the first embodiment (see FIG. 3).

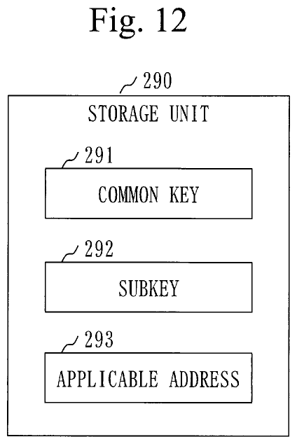

In FIG. 12, the configuration of the storage unit 290 will be described.

In the storage unit 290, an applicable address 293 is pre-stored in addition to the common key 291 and the subkey 292. That is, the applicable address 293 is set in the slave device 200.

The applicable address 293 is an address that is set as the transmission source address of a frame for which data concatenation is allowed.

The details of the applicable address 293 will be described later.

Based on FIG. 12, the configuration of the master device 300 will be described.

The master device 300 further includes a segment management unit 330. The rest of the configuration is the same as the configuration in the first embodiment (see FIG. 6).

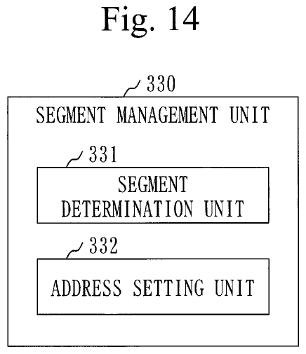

Based on FIG. 14, the configuration of the segment management unit 330 will be described.

The segment management unit 330 includes a segment determination unit 331 and an address setting unit 332.

Description of Operation

The transmission process of the slave device 200 is the same as the transmission process in the first embodiment (see FIG. 7).

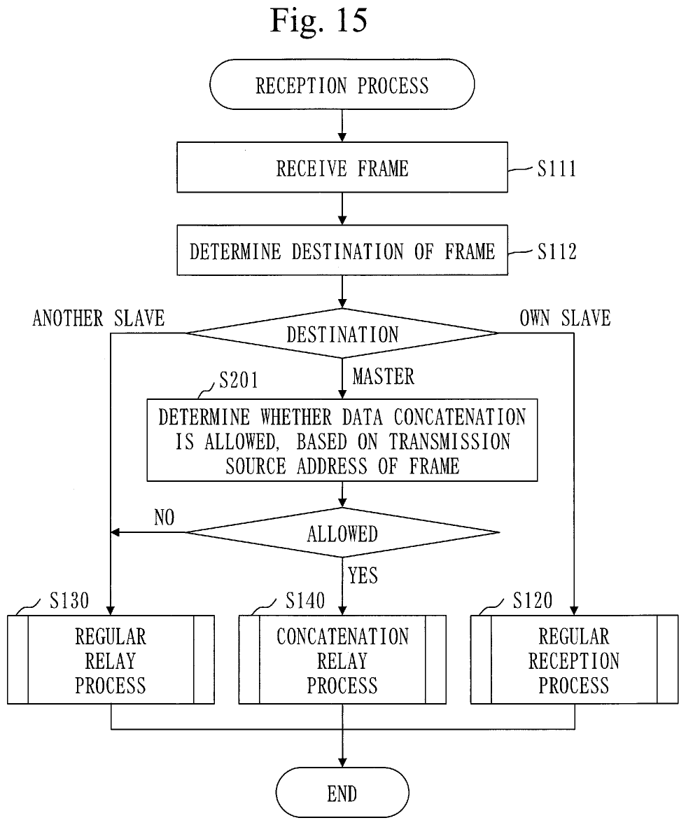

Based on FIG. 15, the reception process of the slave device 200 will be described.

Step S111 and step S112 are as described in the first embodiment (see FIG. 8).

If the destination of the received frame is the master 101, the process proceeds to step S201.

In step S201, the concatenation determination unit 225 determines whether data concatenation is allowed, based on the transmission source address of the received frame.

Specifically, the concatenation determination unit 225 compares the transmission source address of the received frame with the applicable address 293. If the transmission source address matches the applicable address 293, the concatenation determination unit 225 determines that data concatenation is allowed. If the transmission source address does not match the applicable address 293, the concatenation determination unit 225 determines that data concatenation is not allowed.

If it is determined that data concatenation is allowed, the process proceeds to step S140. The concatenation relay process (S140) is as described in the first embodiment (see FIG. 9).

If it is determined that data concatenation is not allowed, the process proceeds to step S130. In step S130, the transmission unit 224 transmits the received frame to the upstream side.

The details of the applicable address 293 will now be described. The slave 102 to be described will be referred to as the slave device 200.

The plurality of slaves 102 are segmented into one or more slave groups. A slave group is one or more slaves 102. A communication time in each slave group is less than a constraint time. The communication time is the time required for a frame to reach the master 101 from the most downstream slave 102 in each slave group. The constraint time is the time defined by a communication period constraint required of the control system 100.

The slave 102 adjacent, in the slave group to which the slave device 200 belongs, to the slave device 200 on the downstream side of the slave device 200 will be referred to as a “virtual adjacent slave”. That is, the virtual adjacent slave is the slave 102 located at the smallest number of hops from the downstream-side interface 206 in the slave group to which the slave device 200 belongs. The slave 102 that is physically connected with the downstream-side interface 206 of the slave device 200 will be referred to as a “physical adjacent slave”.

The applicable address 293 is the address of the virtual adjacent slave. That is, if a frame destined for the master 101 and transmitted from the virtual adjacent slave is received, the slave device 200 performs the concatenation relay process (S140). If a frame destined for the master 101 and transmitted from the physical adjacent slave (excluding the virtual adjacent slave) is received, the slave device 200 performs the regular relay process (S130).

The applicable address 293 is set in the slave device 200 by the master 101. Specifically, the applicable address 293 is set in the slave device 200 before the communication of a frame from each slave 102 to the master 101 is started.

The segment determination unit 331 segments the plurality of slaves 102 into one or more slave groups, based on the constraint time. A specific example of processing by the segment determination unit 331 will be described later.

The address setting unit 332 selects the slave group to which the slave device 200 belongs from the one or more slave groups, and selects the virtual adjacent slave of the slave device 200 from the selected slave group. Then, the address setting unit 332 sets the address of the virtual adjacent slave (applicable address 293) in the slave device 200 by communicating with the slave device 200.

A specific example of processing by the segment determination unit 331 will be described.

The segment determination unit 331 uses an approximate solution that segments the plurality of slaves 102 into one or more slave groups. However, the segment determination unit 331 may use a different approximate solution or exact solution.

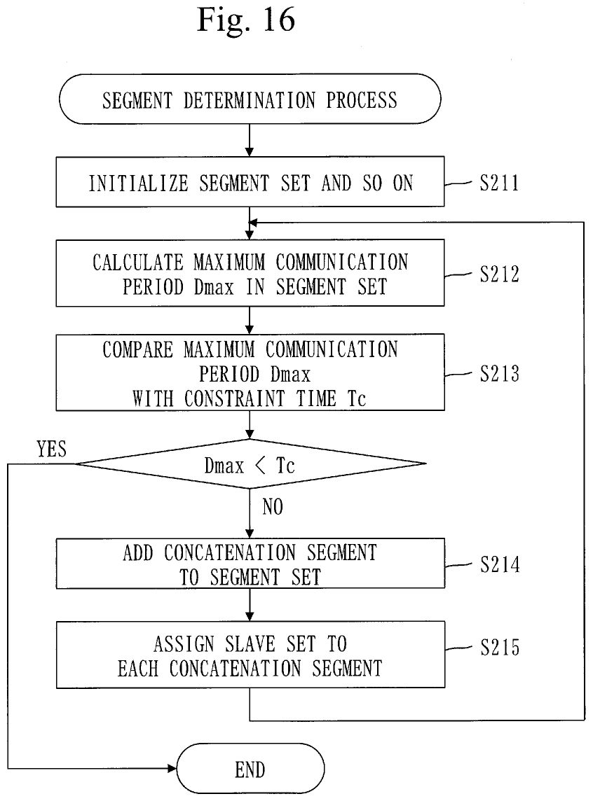

Based on FIG. 16, a segment determination process will be described.

In step S211, the segment determination unit 331 initializes a segment set C and a slave set SC(cⱼ) of each concatenation segment cⱼ.

The segment set C is M concatenation segments {c₁, . . . , c_{M}}. “M” is an integer from 1 to N. “N” is the number of the slaves 102.

The concatenation segment cⱼ is a segment for determining whether data concatenation is to be performed, and corresponds to a slave group.

The slave set SC(cⱼ) is one or more slaves 102 belonging to the concatenation segment cⱼ.

The initialization of the segment set C can be represented as expression (2-1).

C←{c₀} (2-1)

The initialization of the slave set SC(cⱼ) can be represented as expression (2-2). “S” denotes the N slaves 102.

SC(c₀)←S (2-2)

S={s_1, . . . s_N}

In step S212, the segment determination unit 331 calculates a maximum communication time Dₘₐₓ in the segment set C.

The maximum communication time Dₘₐₓ is the maximum value of a communication time D_{rcv}(cⱼ) in the segment set C.

The communication time D_{rcv}(cⱼ) is the time required from start of the transmission process of a frame by the most downstream slave 102 in the concatenation segment cⱼ until the frame arrives at the master 101.

The larger the number of concatenation segments cⱼ included in the segment set C, the shorter the communication time D_{rcv}(cⱼ). When the segment set C is composed of one concatenation segment cⱼ, the communication time D_{rcv}(cⱼ) is the maximum.

That is, the segment determination unit 331 calculates the communication time D_{rcv}(cⱼ) of each concatenation segment cⱼ included in the segment set C, and selects the maximum communication time D_{rcv}(cⱼ). The selected communication time D_{rcv}(cⱼ) is the maximum communication time Dₘₐₓ.

The communication time D_{rcv}(cⱼ) is calculated based on various parameters, such as a transmission data size of each slave 102 belonging to the concatenation segment cⱼ, a MAC operation time depending on each transmission data size, and a frame relay time depending on each transmission data size. The various parameters are pre-stored in the storage unit 390.

In step S213, the segment determination unit 331 compares the maximum communication time Dₘₐₓ with a constraint time T_{c}.

If the maximum communication time Dₘₐₓ is less than the constraint time T_{c}, the segment determination process ends.

If the maximum communication time Dₘₐₓ is equal to or greater than the constraint time T_{c}, the process proceeds to step S214.

In step S214, the segment determination unit 331 adds a concatenation segment c_{|c|+1} to the segment set C as a new element.

The addition of the concatenation segment c_{|c|+1} can be represented as expression (2-3).

[Formula 6]

C←C∪{c_{|c|+1}} (2-3)

In step S215, the segment determination unit 331 determines the configuration of the slave set SC(cⱼ) for each concatenation segment cⱼ included in the segment set C.

Specifically, the segment determination unit 331 assigns each of the slaves 102 to one of the concatenation segments cⱼ sequentially, starting with the most upstream slave 102. The assignment of the slave s_i is performed as described below. The larger the “i” of the slave s_i, the more upstream it is located. That is, the larger the “i” of the slave s_i, the nearer it is to the master 101.

First, the segment determination unit 331 calculates the communication time D_{rcv}(cⱼ) in each of the concatenation segments cⱼ.

Then, the segment determination unit 331 selects a concatenation segment cⱼ corresponding to the minimum communication time D_{rcv}(cⱼ).

Then, the segment determination unit 331 adds the slave s_i to the selected concatenation segment cⱼ.

The addition of the slave s_i can be represented as expression (2-4).

[Formula 7]

SC(cⱼ)←SC(cⱼ)∪{s_i} (2-4)

After step S215, the process proceeds to step S212.

Effects of Second Embodiment

In the second embodiment, the plurality of slaves 102 are segmented into a plurality of groups, depending on the communication period constraint. Then, concatenation of transmission data is performed in each segment. Therefore, an accumulated relay delay can be reduced. As a result, the communication period constraint can be satisfied.

Supplement to Embodiments

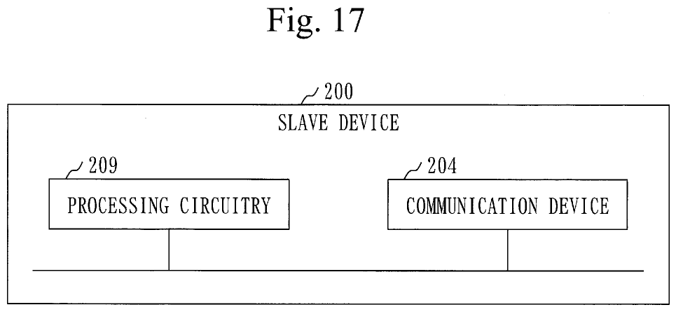

Based on FIG. 17, a hardware configuration of the slave device 200 will be described.

The slave device 200 includes processing circuitry 209.

The processing circuitry 209 is hardware that realizes the application unit 210 and the communication management unit 220.

The processing circuitry 209 may be dedicated hardware, or may be the processor 201 that executes programs stored in the memory 202.

When the processing circuitry 209 is dedicated hardware, the processing circuitry 209 is, for example, a single circuit, a composite circuit, a programmed processor, a parallel-programmed processor, an ASIC, an FPGA, or a combination of these.

ASIC is an abbreviation for Application Specific Integrated Circuit.

FPGA is an abbreviation for Field Programmable Gate Array.

The slave device 200 may include a plurality of processing circuits as an alternative to the processing circuitry 209. The plurality of processing circuits share the role of the processing circuitry 209.

In the processing circuitry 209, some of the functions may be realized by dedicated hardware, and the rest of the functions may be realized by software or firmware.

As described above, the processing circuitry 209 can be realized by hardware, software, firmware, or a combination of these.

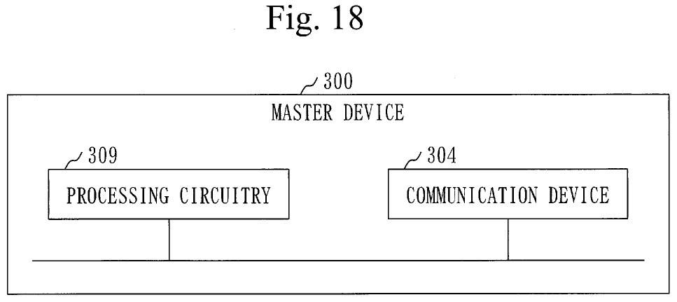

Based on FIG. 18, a hardware configuration of the master device 300 will be described.

The master device 300 includes processing circuitry 309.

The processing circuitry 309 is hardware that realizes the application unit 310, the communication management unit 320, and the segment management unit 330.

The processing circuitry 309 may be dedicated hardware, or may be the processor 301 that executes programs stored in the memory 302.

When the processing circuitry 309 is dedicated hardware, the processing circuitry 309 is, for example, a single circuit, a composite circuit, a programmed processor, a parallel-programmed processor, an ASIC, an FPGA, or a combination of these.

The master device 300 may include a plurality of processing circuits as an alternative to the processing circuitry 309. The plurality of processing circuits share the role of the processing circuitry 309.

In the processing circuitry 309, some of the functions may be realized by hardware, and the rest of the functions may be realized by software or firmware.

As described above, the processing circuitry 309 can be realized by hardware, software, firmware, or a combination of these.

The embodiments are examples of preferred embodiments and are not intended to limit the technical scope of the present invention. Each of the embodiments may be implemented partially, or may be implemented in combination with another embodiment. The procedures described using flowcharts or the like may be modified as appropriate.

Each “unit”, which is an element of the slave device 200 or the master device 300, may be interpreted as “process” or “step”.

### REFERENCE SIGNS LIST

100: control system, 101: master, 102: slave, 111: frame, 112: frame, 113: frame, 114: frame, 200: slave device, 201: processor, 202: memory, 203: auxiliary storage device, 204: communication device, 205: upstream-side interface, 206: downstream-side interface, 209: processing circuitry, 210: application unit, 220: communication management unit, 221: reception unit, 222: acceptance unit, 223: regular relay unit, 224: transmission unit, 225: concatenation determination unit, 230: concatenation relay unit, 231: verification unit, 232: separation unit, 233: intermediate-computation-result calculation unit, 234: transmission data concatenation unit, 235: MAC calculation unit, 236: frame generation unit, 290: storage unit, 291: common key, 292: subkey, 293: applicable address, 300: master device, 301: processor, 302: memory, 303: auxiliary storage device, 304: communication device, 305: communication interface, 309: processing circuitry, 310: application unit, 320: communication management unit, 330: segment management unit, 331: segment determination unit, 332: address setting unit, 390: storage unit

1. A slave device comprising:
processing circuitry to:
receive a frame destined for a master located on an upstream side from a slave located on a downstream side;
calculate an intermediate computation result, using a received message authentication code, which is a message authentication code included in the received frame, the intermediate computation result being obtained by computing a part of a computation expression for calculating the received message authentication code;
concatenate transmission data, which is to be transmitted to the master, to a transmission data string included in the received frame;
calculate a message authentication code for a concatenated transmission data string, using the intermediate computation result;
determine whether data concatenation is allowed, based on a transmission source address of the received frame; and
transmit a frame including the concatenated transmission data string and including the message authentication code calculated using the intermediate computation result, in place of the received message authentication code, to the upstream side when it is determined that data concatenation is allowed, and transmit the received frame to the upstream side when it is determined that data concatenation is not allowed.

2. The slave device according to claim 1,
wherein an applicable address is set in the slave device as a transmission source address of a frame for which data concatenation is allowed, and
wherein the processing circuitry determines that data concatenation is allowed when the transmission source address of the received frame matches the applicable address.

3. The slave device according to claim 2,
wherein the slave device is one slave of a plurality of slaves that constitute a control system together with the master,
wherein the plurality of slaves are segmented into one or more slave groups, and
wherein the applicable address is an address of a slave adjacent, in a slave group to which the slave device belongs, to the slave device on the downstream side of the slave device.

4. The slave device according to claim 3,
wherein a time required for a frame to reach the master from a most downstream slave in each slave group is less than a constraint time required of the control system.

5. The slave device according to claim 4,
wherein the master segments the plurality of slaves into the one or more slave groups based on the constraint time, and sets the applicable address in the slave device by communicating with the slave device.

6. The slave device according to claim 1,
wherein a message authentication code for each frame is a value calculated by a message authentication code algorithm based on a block cipher, and
wherein the processing circuitry performs a decryption operation performed on the received message authentication code using a common key that is same as a key used in the computation expression, and performs an exclusive OR operation on a value obtained by the decryption operation and a subkey corresponding to the common key, so as to calculate a value obtained by the exclusive OR operation as the intermediate computation result.

7. The slave device according to claim 2,
wherein a message authentication code for each frame is a value calculated by a message authentication code algorithm based on a block cipher, and
wherein the processing circuitry performs a decryption operation performed on the received message authentication code using a common key that is same as a key used in the computation expression, and performs an exclusive OR operation on a value obtained by the decryption operation and a subkey corresponding to the common key, so as to calculate a value obtained by the exclusive OR operation as the intermediate computation result.

8. The slave device according to claim 3,
wherein a message authentication code for each frame is a value calculated by a message authentication code algorithm based on a block cipher, and
wherein the processing circuitry performs a decryption operation performed on the received message authentication code using a common key that is same as a key used in the computation expression, and performs an exclusive OR operation on a value obtained by the decryption operation and a subkey corresponding to the common key, so as to calculate a value obtained by the exclusive OR operation as the intermediate computation result.

9. The slave device according to claim 4,
wherein a message authentication code for each frame is a value calculated by a message authentication code algorithm based on a block cipher, and
wherein the processing circuitry performs a decryption operation performed on the received message authentication code using a common key that is same as a key used in the computation expression, and performs an exclusive OR operation on a value obtained by the decryption operation and a subkey corresponding to the common key, so as to calculate a value obtained by the exclusive OR operation as the intermediate computation result.

10. The slave device according to claim 5,
wherein a message authentication code for each frame is a value calculated by a message authentication code algorithm based on a block cipher, and
wherein the processing circuitry performs a decryption operation performed on the received message authentication code using a common key that is same as a key used in the computation expression, and performs an exclusive OR operation on a value obtained by the decryption operation and a subkey corresponding to the common key, so as to calculate a value obtained by the exclusive OR operation as the intermediate computation result.

11. A non-transitory computer readable medium storing a slave program for causing a computer to execute:
a reception process of receiving a frame destined for a master located on an upstream side from a slave located on a downstream side;
an intermediate-computation-result calculation process of calculating an intermediate computation result, using a received message authentication code, which is a message authentication code included in the received frame, the intermediate computation result being obtained by computing a part of a computation expression for calculating the received message authentication code;
a transmission data concatenation process of concatenating transmission data, which is to be transmitted to the master, to a transmission data string included in the received frame;
a message authentication code calculation process of calculating a message authentication code for a concatenated transmission data string, using the intermediate computation result;
a concatenation determination process of determining whether data concatenation is allowed, based on a transmission source address of the received frame; and
a transmission process of transmitting a frame including the concatenated transmission data string and including the message authentication code calculated using the intermediate computation result, instead of the received message authentication code, to the upstream side when it is determined that data concatenation is allowed, and transmitting the received frame to the upstream side when it is determined that data concatenation is not allowed.
